(19) United States
(12) Patent Application Publication
(10) Pub. No.: US 2015/0213179 A1
(43) Pub. Date: Jul. 30, 2015

(54) LEAKAGE POWER REDUCTION IN INTEGRATED CIRCUITS BY SELECTIVE REMOVAL AND/OR SIZING OF SWITCH CELLS

(71) Applicant: Samsung Electronics Co., Ltd., Suwon-si (KR)

(72) Inventors: Harish DANGAT, San Jose, CA (US); Prasanth KODURI, Fremont, CA (US); Sarita BASWANT, Cupertino, CA (US)

(73) Assignee: Samsung Electronics Co., Ltd., Suwon-si (KR)

(21) Appl. No.: 14/167,983

(22) Filed: Jan. 29, 2014

(51) Int. Cl. G06F 17/50

(52) U.S. Cl. CPC G06F 17/5072; G06F 17/5077

(57) ABSTRACT

According to one general aspect, a method may include receiving a placed and routed circuit design, wherein the placed and routed circuit design includes a plurality of switch cells. The method may include performing a supply voltage drop analysis on the placed and routed circuit design. The method may also include creating a voltage drop map detailing a plurality of supply voltage drops across the placed and routed circuit design as a function of physical position. The method may further include determining one or more low voltage drop portions of the placed and routed circuit design that are associated with respective voltage drops below a predetermined threshold value. The method may include altering one or more switch cells included by the respective one or more low voltage portions.

### TECHNICAL FIELD

This description relates to the design of an integrated circuit, and more specifically to specifically leakage power saving in an integrated circuit.

### BACKGROUND

Generally, “sleep mode” refers to a low power mode for electronic devices such as computers, televisions, and remote controlled devices. This mode often saves significant electrical power compared to leaving a device fully on, and often allows the user to avoid having to reissue instructions or wait for a machine to reboot. Often in sleep mode the computer cuts power to unneeded subsystems and places other subsystems into a minimum power state, just sufficient to retain its data. Because of the large power saving, most laptops and many other computing devices frequently automatically enter this mode when the computer is running on batteries and are inactive for a period of time. Further, even if the general device remains “on” or at full power, unused subsystems (e.g., a floating-point unit, a high-end graphics processor, etc.) may be powered off or placed in a sleep mode if the overall computer has not made use of that subsystem for a period of time.

“Standby power” generally refers to the electric power consumed by electronic and electrical appliances while they are switched off (but are designed to draw some power) or in a standby mode. Generally, even when in sleep mode the computer or electrical device draws a minimal amount of power. Often part of that power is leakage current.

In electronics, leakage or “leakage current” may refer to a gradual loss of energy from a charged capacitor, such as transistors or diodes, which conduct a small amount of current even when they are turned off. Another contributor to leakage from a capacitor is from the undesired imperfections of some dielectric materials used in capacitors, also known as dielectric leakage. This is a result of the dielectric material not being a perfect insulator and having some non-zero conductivity, allowing a leakage current to flow, slowly discharging the capacitor. Even though this off current is generally an order of magnitude less than the current through the device when it is on, the current still slowly discharges the capacitor and therefore causes a drain or consumption of power. Generally, as transistor sizes shrink, the amount leakage current increases.

### SUMMARY

According to one general aspect, a method may include receiving a placed and routed circuit design, wherein the placed and routed circuit design includes a plurality of switch cells. The method may include performing a supply voltage drop analysis on the placed and routed circuit design. The method may also include creating a voltage drop map detailing a plurality of supply voltage drops across the placed and routed circuit design as a function of physical position. The method may further include determining one or more low voltage drop portions of the placed and routed circuit design that are associated with respective voltage drops below a predetermined threshold value. The method may include altering one or more switch cells included by the respective one or more low voltage portions.

According to another general aspect, an apparatus may include a supply voltage drop analyzer and a processor. The supply voltage drop analyzer may be configured to perform a supply voltage drop analysis on a placed and routed circuit design, wherein the placed and routed circuit design includes a plurality of switch cells, and create a voltage drop map detailing a plurality of supply voltage drops across the placed and routed circuit design as a function of physical position. The processor may be configured to determine one or more low voltage drop portions of the placed and routed circuit design that are associated with respective voltage drops below a predetermined threshold value, and alter one or more switch cells included by the respective one or more low voltage portions.

According to another general aspect, a computer program product for designing an integrated circuit may be tangibly and non-transitorily embodied on a computer-readable medium. The computer program product may include executable code for execution on an apparatus. The executable code may include instructions to receive a placed and routed circuit design, wherein the placed and routed circuit design includes a plurality of switch cells. The executable code may include instructions to perform a supply voltage drop analysis on the placed and routed circuit design. The executable code may include instructions to create a voltage drop map detailing a plurality of supply voltage drops across the placed and routed circuit design as a function of physical position. The executable code may include instructions to determine one or more low voltage drop portions of the placed and routed circuit design that are associated with respective voltage drops below a predetermined threshold value. The executable code may include instructions to alter one or more switch cells included by the respective one or more low voltage portions.

The details of one or more implementations are set forth in the accompanying drawings and the description below. Other features will be apparent from the description and drawings, and from the claims.

A system and/or method for the design of an integrated circuit, substantially as shown in and/or described in connection with at least one of the figures, as set forth more completely in the claims.

### BRIEF DESCRIPTION OF THE DRAWINGS

FIG. 1 is a block diagram of an example embodiment of two circuits that may be employed in accordance with the disclosed subject matter.

FIG. 2 is a block diagram of an example embodiment of a system in accordance with the disclosed subject matter.

FIG. 3 is a block diagram of an example embodiment of a system in accordance with the disclosed subject matter.

FIG. 4 is a flowchart of an example embodiment of a technique in accordance with the disclosed subject matter.

FIG. 5 is a schematic block diagram of an information processing system, which may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

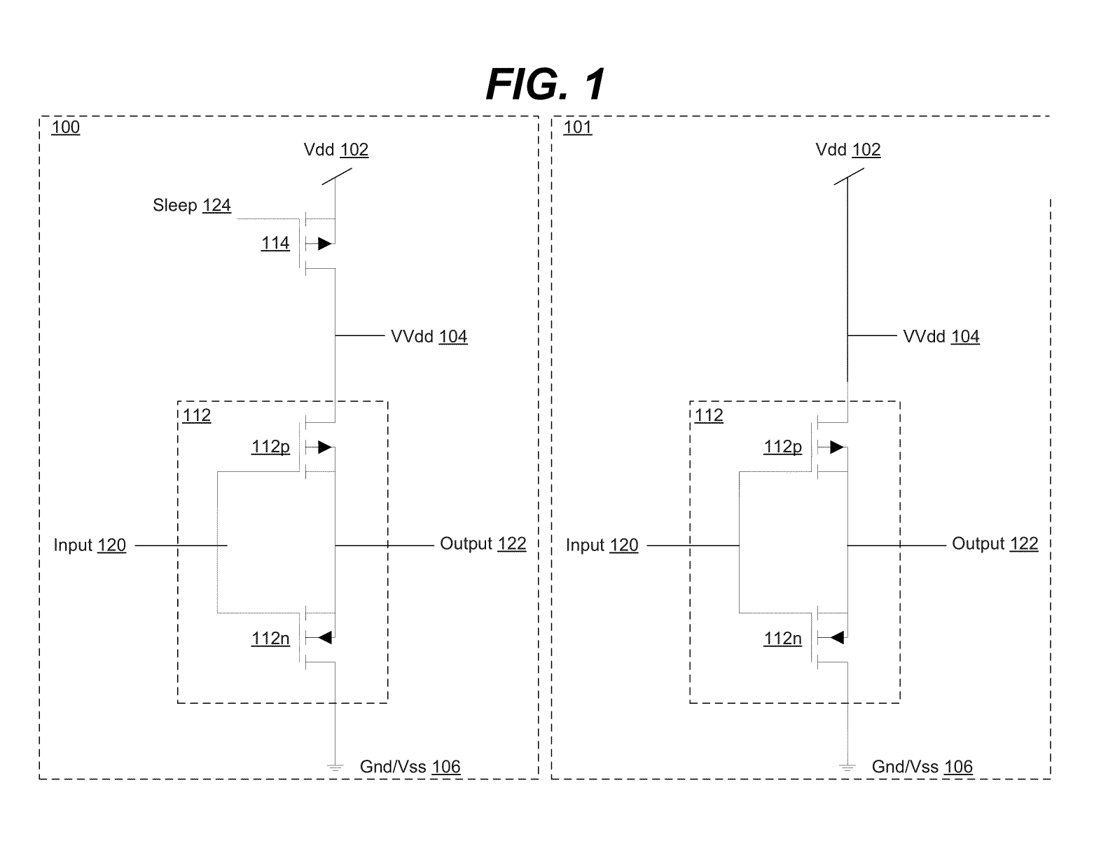

FIG. 1 is a block diagram of an example embodiment of two circuits that may be employed in accordance with the disclosed subject matter. In one embodiment, the gated circuit 100 may be employed and, in another embodiment, the un-gated circuit 101 may be employed.

In various embodiments, the technique of “power gating” may be employed to reduce power consumption in a circuit or integrated circuit (e.g., a processor, a system-on-a-chip (SoC), etc.). In such an embodiment, power gating may reduce power consumption by shutting off the current (or voltage) to blocks of the circuit that are not in use. However, the additional circuitry used to effect the power gating may itself introduce its own leakage current. Therefore, it is desirable in the disclosed subject matter to be selective or discerning about how power gating is employed.

In the illustrated embodiment, the un-gated circuit 101 may include some form of logic block 112. In the illustrated embodiment, this is represented as a NOT gate that includes the transistors 112p and 112n; although, it is understood that the above is merely one illustrative example to which the disclosed subject matter is not limited. In various embodiments, the logic block 112 may be far more complex than that illustrated (e.g., a portion of a floating-point unit (FPU), a vertex shader, etc.). In various embodiments, the logic block 112 may receive various input(s) 120 and generate various output(s) 122, depending upon the action performed by the logic block 112.

In one embodiment, the logic block 112 may operate using two power rails or power supplies. In the illustrated embodiment, the lower power rail may be ground (GND) or Vss 106. In some embodiments, the upper or higher power rail may include Vdd 102 (e.g., 5 volt (V), 1 V, 0.9 V, 0.6 V, etc.). In various embodiments, the value of Vdd 102 may depend upon the size or process employed to manufacture the transistors 112p & 112n of the logic block 112. In such an embodiment, a smaller process (e.g., 45 nanometers (nms), 22 nms, 14 nms, 10 nms, etc.) may correlate with a lower Vdd 102. It is understood that the above are merely a few illustrative examples to which the disclosed subject matter is not limited.

In the illustrated embodiment, the un-gated circuit 101 may be coupled directly with the power supply voltage Vdd 102. Therefore, in such an embodiment, it may not be possible to power gate the logic block 112.

Conversely, the gated circuit 100 may include the logic block 112 (or a similar logic block), but may also include a switch cell 114. In various embodiments, the switch cell 114 may be configured to gate, control, or regulate the power supply or voltage applied to the logic circuit 112. In such an embodiment, the switch cell 114 may be placed in between the logic circuit 112 and the power supply Vdd 102. In such an embodiment, the logic circuit 112 may employ the voltage VVdd 104 as its upper rail. The voltage VVdd 104 may be the output of the switch cell 114.

In various embodiments, when the switch cell 114 is turned “on”, the voltage VVdd 104 may be substantially equivalent to the voltage Vdd 102, and the logic block 112 may operate normally. Conversely, in various embodiments, when the switch cell 114 is turned “off”, the voltage VVdd 104 may be substantially close enough to the lower rail Vss 106 that the logic block 112 may not operate normally and is turned “off” or placed in a sleep mode.

In such an embodiment, the logic circuit 112 may be power gated. In the illustrated embodiment, the switch cell 114 may be controlled by the sleep signal 124. Further, it is understood that while the switch cell 114 is illustrated as including a transistor this is merely one illustrative example of a switch cell 114 to which the disclosed subject matter is not limited.

While, in general, power gating the logic block 112 may save power, in various embodiments, the switch cell 114 may include its own leakage current and therefore, the introduction of a switch cell 114 increases the power consumption of the device, especially when the logic block 112 is in normal or un-gated operation. In a traditional system, switch cells 114 (or similar gating circuits) are added at regular intervals (e.g., to all power supply circuits or sub-circuits) within an integrated circuit. In various embodiments, a way to reduce the number of switch cells 114 in an integrated device may be desirable.

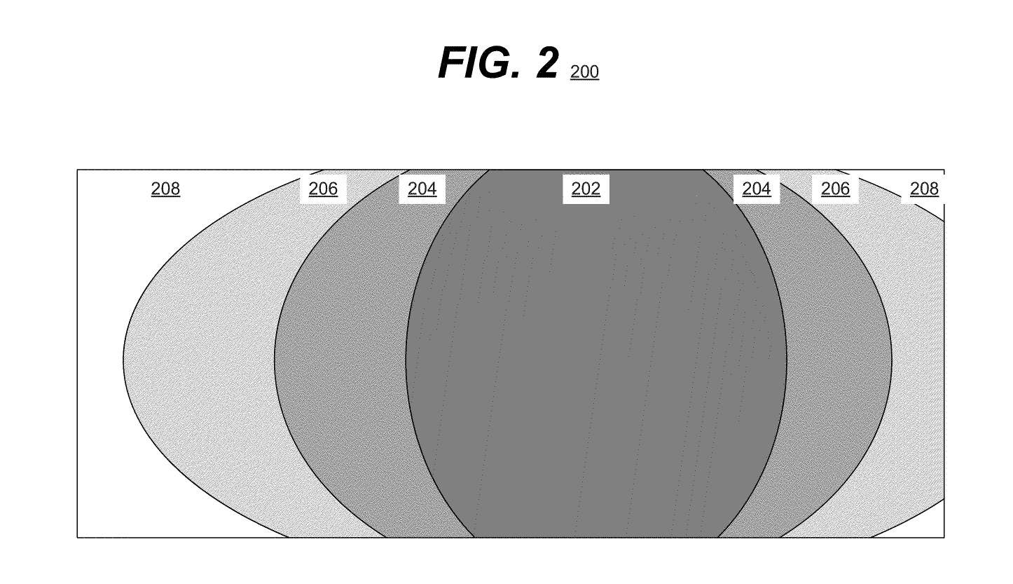

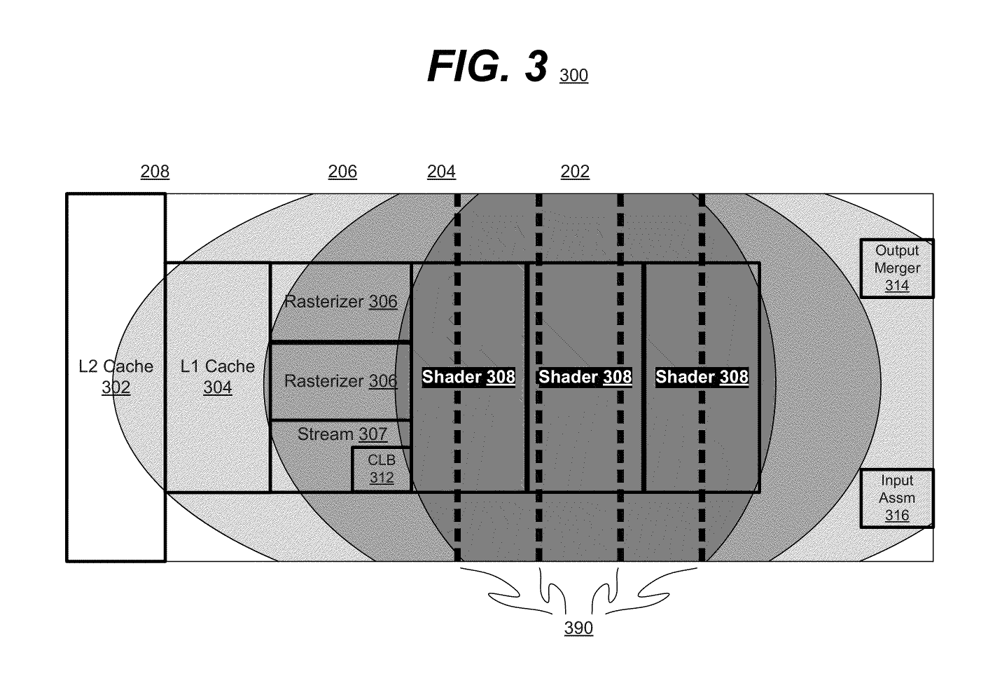

FIG. 2 is a block diagram of an example embodiment of a system or integrated circuit 200 in accordance with the disclosed subject matter. In various embodiments, the integrated circuit 200 may include a plurality of transistors (e.g., illustrated as logic block 112 of FIG. 1) or sub-circuits (e.g., those illustrated in FIG. 3).

In various embodiments, the creation of the integrated circuit 200 may have undergone a number of design phases. Traditionally, these design phases may be divided into logic or circuit design, and physical design. Generally, logic design is a process by which an abstract form of desired circuit behavior is turned into a design implementation in terms of logic gates and may include steps or phases, such as, for example, specification, architecture design, functional or logic design, circuit design, etc. Generally, physical design is a step in the standard design cycle that follows the circuit design phase. At this step, circuit representations of the components (devices and interconnects) of the design are converted into geometric representations of shapes which, when manufactured in the corresponding layers of materials, will ensure the required functioning of the components. In various embodiments, the steps or phases of physical design may include, but are not limited to, partitioning, floor planning, placement, signal routing, etc.

In various embodiments, during the logic design phase the number or general placement of switching cells are determined. However, in some embodiments, the amount of switching cells is over-estimated at this phase of design. Further, it may be difficult to accurately estimate the number of switching cells to employ as any leaking current estimates are theoretical as the circuit only exists in logic models (e.g., register transfer logic (RTL), etc.).

As a result, in a preferred embodiment, the disclosed subject matter may be employed during the physical design phase(s) of integrated circuit design. In such an embodiment, the leakage current may actually be measured or more accurately simulated. However, in a less preferred embodiment, disclosed subject matter may be employed during the logic design phase(s) of integrated circuit design or any design phase.

As described above, in various embodiments, during the logic design phase a certain number of switch cells may have been assigned and placed within the integrated circuit (or the model thereof). As described above, in various embodiments, this certain number of switch cells may be greater than truly desired.

In various embodiments, at the end of or after the logic design phase (e.g., during the signal routing phase, etc.) a voltage drop analysis may be performed on the placed and routed circuit design. In this context, the term “voltage drop” describes how the supplied energy of a voltage source (e.g., Vdd, VVdd, etc.) is reduced as electric current moves through the elements of an electrical circuit. In some embodiments, the voltage drop may be referred to as an “IR drop” as under Ohm's Law voltage (V) is equal to current (I) times resistance (R) (i.e. V=IR).

In some embodiments, analyzing the voltage drop of the integrated circuit may include a simulation based upon the placed and routed circuit design. In another embodiment, analyzing the voltage drop of the integrated circuit may include measuring an actual voltage drop or physical characteristics (e.g., current drop, current value, temperature, etc.) of an actual physical version of the integrated circuit. In one such embodiment, the analyzing the voltage drop of the integrated circuit may include performing either static IR drop analysis, dynamic IR drop analysis, or a combination thereof. In various embodiments, a static IR drop analysis may include determining an average voltage drop. Conversely, a dynamic IR drop may include analyzing the voltage drop (or series of voltage drops) that occurs when the logic circuits switch, and therefor may depend upon the inputs provided to the integrated circuit and may be transient (occurring or peaking only for a few clock cycles). It is understood that the above are merely a few illustrative examples to which the disclosed subject matter is not limited.

In one embodiment, analyzing the voltage drop may include generating a “heat map” or more accurately a “voltage drop map” such as that shown in FIG. 2. In such an embodiment, the “heat map” may include a graphical (or logical or virtual) representation of data (e.g., voltage drop, etc.) where the individual values contained in a matrix are represented as colors, value categories, or bands. In various embodiments, a “voltage drop map” may include a heat map associating or correlating voltage drop data points to physical locations of the integrated circuit 200. In such an embodiment, it may be simple to see what parts or portions of the integrated circuit are experiencing the highest (or lowest) voltage drops.

In the illustrated embodiment, the circuit 200 may include a plurality (here, four) bands or ranges of voltage drops 202, 204, 206, and 208. In such an embodiment, the highest voltage drop may occur within range 202, the second highest within range 204, the third highest within range 206, and the lowest within range 208. It is understood that the illustrated are merely illustrative examples to which the disclosed subject matter is not limited.

In various embodiments, the switch cells in the lower voltage drop region (e.g., those within the range 208) may be removed. In another embodiment, only a portion of the switch cells within an intermediate voltage drop region (e.g., those within the range 206) may be removed. Likewise, in various embodiments, a lesser portion of the switch cells within another intermediate voltage drop region (e.g., those within the range 204) may be removed. In such an embodiment, even fewer or none of the switch cells within the highest voltage drop region (e.g., those within the range 202) may be removed. It is understood that the above are merely a few illustrative examples to which the disclosed subject matter is not limited.

In various embodiments, as switch cells are removed, the leakage current incurred due to the switch cells may be reduced. In such an embodiment, the number of switch cells of the integrated circuit 200 may be tailored based upon the amount of voltage drop associated with each region of the integrated circuit. In such an embodiment, the amount of leakage current may be reduced, overall, and more specifically within a given region of the integrated circuit, if the voltage drop does not warrant more aggressive power gating. In various embodiments, reducing the number of switch cells within a given region may increase the voltage drop within that region.

In various embodiments, a tiered approach may be employed when analyzing the voltage drop of the integrated circuit 200. In such an embodiment, a plurality of predetermined voltage drop tiers or ranges may be predefined. In various embodiments, each portion of the integrated circuit 200 may be associated with one of these tiers. In such an embodiment, each tier may be associated with a different remedial scheme for altering the switch cells within the portions of the integrated circuit 200 associated with that tier. For example, in one embodiment the above concept of removing all or none of the switch cells within a region may be employed. In another embodiment, schemes may be employed that include: a predefined percentage of switch cells being removed, switch cells within a certain spacing being removed, etc. It is understood that the above are merely a few illustrative examples to which the disclosed subject matter is not limited.

In various embodiments, the switch cells may not just be removed, but may more generally be altered. In such an embodiment, the switch cells may be resized (e.g., made smaller, made larger, etc.). In another embodiment, an existing plurality of switch cells of a first size may be replaced by a second plurality of switch cells of a second size (e.g., 2 or 3 small switch cells may be replaced by a single larger switch cell, etc.). In yet another embodiment, altering the switch cells may include altering the type of switch cells used with a region (e.g., changing transistor types, etc.). In various embodiments, only a portion of the switch cells within a voltage drop region may be altered (e.g., removed, resized, converted, etc.). In one embodiment, altering switch cells within a voltage drop region may include a combination of techniques. It is understood that the above are merely a few illustrative examples to which the disclosed subject matter is not limited.

In various embodiments, the technique described above may be performed iteratively. In such an embodiment, the placed and routed design may be altered (e.g., by altering the switch cells, etc.) to form a new or altered placed and routed design. This new or altered placed and routed design may be the input to the next iterative stage. The voltage drop analysis may be done based upon the new or altered placed and routed design and then based upon the voltage drop analysis the switch cells may be further altered. In such an embodiment, this process may be done again and again until a desired result or steady state is accomplished. In various embodiments, the desired result may be defined as, for example, a level of leakage current, voltage drop, number of switch cells, altered, etc. It is understood that the above is merely one illustrative example to which the disclosed subject matter is not limited.

FIG. 3 is a block diagram of an example embodiment of a system or integrated circuit 300 in accordance with the disclosed subject matter. In various embodiments, the integrated circuit 300 may include a plurality of transistors (e.g., illustrated in logic block 112 of FIG. 1) or sub-circuits (e.g., those illustrated in FIG. 3).

In various embodiments, the integrated circuit 300 may include a number of functional unit blocks (FUBs). In this context, a FUB may include a grouping of logic blocks (e.g., logic block 112, of FIG. 1, etc.) that together perform a function. In various embodiments, a portion of logic devices within a FUB may receive a common power supply (e.g., Vdd, VVdd, etc.) and be subject to common power gating or other power reduction techniques. For example, in a central processing unit (CPU) a FUB may include a floating-point unit (FPU). In such an embodiment, the FPU may be turned on or off as a whole based upon the power needs or mode of the CPU. For example, if only integer arithmetic is being performed the FPU may be turned off. It is understood that the above is merely one illustrative example to which the disclosed subject matter is not limited.

In the illustrated embodiment, the integrated circuit 300 may include a number of FUBs: a level 2 (L2) cache 302, a level 1 (L1) cache 304, a plurality of rastertizer engines 306, a plurality of shader engines 308, a streaming engine 307, an input assembler 316, and an output merger engine 314. It is understood that the above are merely a few illustrative examples to which the disclosed subject matter is not limited.

FIG. 3 illustrates that, in various embodiments, the alteration of the switch cells may occur, not for a voltage drop region as a whole (e.g., all of region 204, etc.), but instead at a FUB-level granularity. For example, in such an embodiment, the whole of the two rasterizer engines 306 may be subject to the same level of switch cell alteration despite the fact that one of the rasterizer engines 306 is illustrated as straddling three voltage drop regions (regions 202, 204, and 206).

Further, in various embodiments, different FUBs may be subject to different switch cell alteration schemes despite being within common voltage drop regions. For example, the L1 cache 304 and the input assembler 316 are both within the region 206. However, due to different considerations (e.g., the L1 cache being primarily memory cells, etc.) the alterations made within those two FUBs may differ (e.g., the L1 cache 304 may employ a different size of switch cell than the input assembler 316, etc.) It is understood that the above is merely one illustrative example to which the disclosed subject matter is not limited.

Further, in various embodiments, further levels of granularity may be employed. In some embodiments, each FUB may include further sub-portions (e.g., combinatorial logic block (CLB) 312, etc.). In such an embodiment, each sub-portion of a FUB may be treated as a whole or group when applying a switch cell alteration scheme. Likewise, different sub-portions may have different switch cell alteration schemes applied to them (similarly to the illustrative example of the L1 cache 304 and the Input Assembler 316, etc.). It is understood that the above are merely a few illustrative examples to which the disclosed subject matter is not limited.

In various embodiments, the integrated circuit 300 may include a plurality of power supply lines 390. In such an embodiment, these power supply lines 390 may occur at various intervals and supply power (e.g., Vdd, VVdd, etc.) across their respective portions of the integrated circuit 300. In various embodiments, these power supply lines 390 may include the switch cells. In such an embodiment, the switch cells may, generally, be spaced or dispersed at regular intervals. In some embodiments, altering the switch cells within a region (e.g., voltage drop region, FUB, etc.) may include altering the intervals at which the switch cells are disposed, or may include altering individual switch cells (e.g., removing, resizing, etc.) such that their dispersal is no longer regular. Further, it is understood that while only a few power supply lines 390 are shown in FIG. 3, the power supply lines 390 may be dispersed throughout the integrated circuit 300. It is understood that the above is merely one illustrative example to which the disclosed subject matter is not limited.

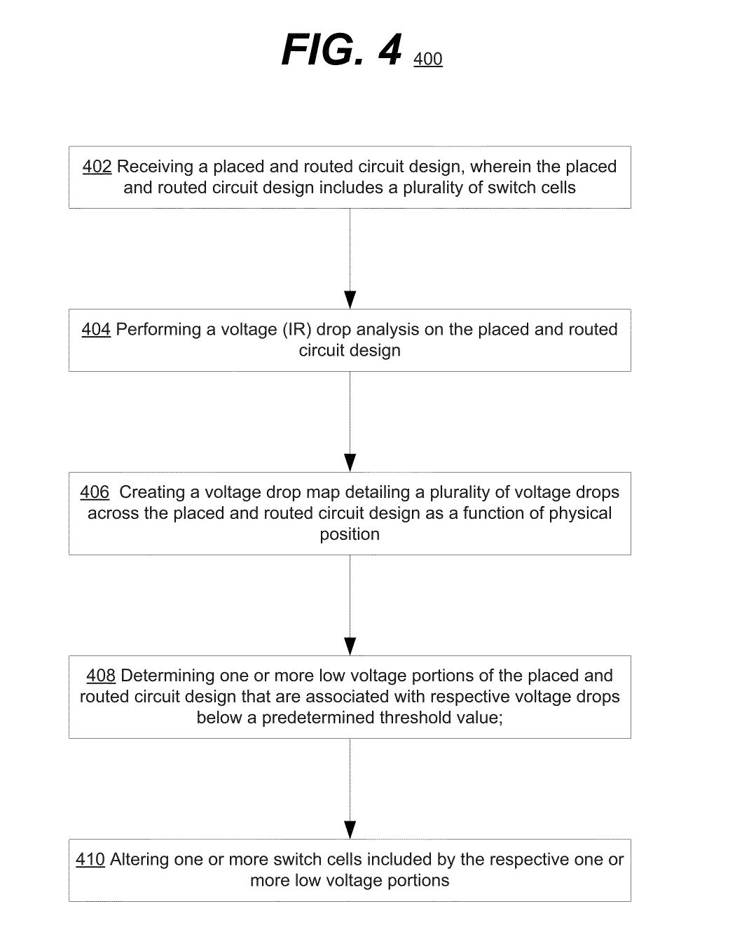

FIG. 4 is a flowchart of an example embodiment of a technique 400 in accordance with the disclosed subject matter. In various embodiments, the technique 400 may be used or produced by the systems such as those of FIG. 1, 2, 3, or 5. Although, it is understood that the above are merely a few illustrative examples to which the disclosed subject matter is not limited. It is understood that the disclosed subject matter is not limited to the ordering of or number of actions illustrated by technique 400.

Block 402 illustrates that, in one embodiment, a placed and routed circuit design may be received, as described above. In various embodiments, the placed and routed circuit design may include a plurality of switch cells, as described above. In some embodiments, receiving a placed and routed circuit design may occur in any stage of integrated circuit design, as described above. In various embodiments, one or more of the action(s) illustrated by this Block may be performed by the apparatuses or systems of FIG. 2, 3, or 5, as described above.

Block 404 illustrates that, in one embodiment, a supply voltage drop analysis may be performed on the placed and routed circuit design, as described above. In various embodiments, performing a voltage drop analysis may include performing a dynamic IR drop analysis, as described above. In various embodiments, one or more of the action(s) illustrated by this Block may be performed by the apparatuses or systems of FIG. 2, 3, or 5, as described above.

Block 406 illustrates that, in one embodiment, a voltage drop map may be created, as described above. In such an embodiment, the voltage drop map may detail a plurality of supply voltage drops across the placed and routed circuit design as a function of physical position, as described above. In various embodiments, one or more of the action(s) illustrated by this Block may be performed by the apparatuses or systems of FIG. 2, 3, or 5, as described above.

Block 408 illustrates that, in one embodiment, it may be determined that one or more low voltage drop portions of the placed and routed circuit design are associated with respective voltage drops below a predetermined threshold value, as described above. In various embodiments, determining one or more low voltage drop portions may include determining portions based upon a functional unit block level of granularity, as described above. In various embodiments, one or more of the action(s) illustrated by this Block may be performed by the apparatuses or systems of FIG. 2, 3, or 5, as described above.

Block 410 illustrates that, in one embodiment, one or more switch cells included by the respective one or more low voltage portions may be altered, as described above. In various embodiments, altering one or more switch cells may include resizing the switching cells, as described above. In another embodiment, altering one or more switch cells may include includes reducing a leakage power associated with the respective low voltage drop portions, as described above. In yet another embodiment, determining one or more low voltage drop portions may include determining a plurality of tiers of voltage drop ranges, each tier associated with a respective threshold value, as described above. In such an embodiment, altering one or more switch cells may include performing a different level of alteration for each low voltage drop portion associated with a respective tier, as described above. In various embodiments, one or more of the action(s) illustrated by this Block may be performed by the apparatuses or systems of FIG. 2, 3, or 5, as described above.

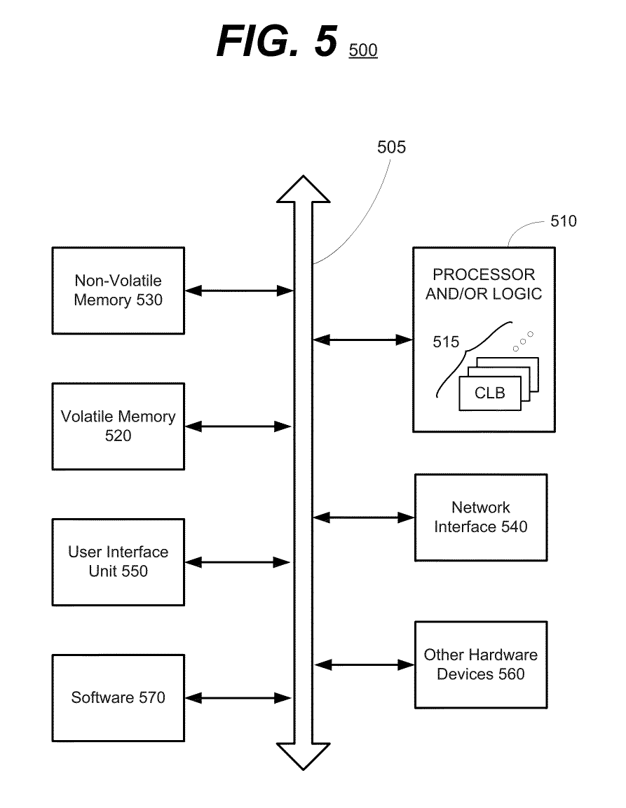

FIG. 5 is a schematic block diagram of an information processing system 500, which may include semiconductor devices formed according to principles of the disclosed subject matter.

Referring to FIG. 5, an information processing system 500 may include one or more of devices constructed according to the principles of the disclosed subject matter. In another embodiment, the information processing system 500 may employ or execute one or more techniques according to the principles of the disclosed subject matter.

In various embodiments, the information processing system 500 may include a computing device, such as, for example, a laptop, desktop, workstation, server, blade server, personal digital assistant, smartphone, tablet, and other appropriate computers, etc. or a virtual machine or virtual computing device thereof. In various embodiments, the information processing system 500 may be used by a user (not shown).

The information processing system 500 according to the disclosed subject matter may further include a central processing unit (CPU), logic, or processor 510. In some embodiments, the processor 510 may include one or more functional unit blocks (FUBs) or combinational logic blocks (CLBs) 515. In such an embodiment, a combinational logic block may include various Boolean logic operations (e.g., NAND, NOR, NOT, XOR, etc.), stabilizing logic devices (e.g., flip-flops, latches, etc.), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 500 according to the disclosed subject matter may further include a volatile memory 520 (e.g., a Random Access Memory (RAM), etc.). The information processing system 500 according to the disclosed subject matter may further include a non-volatile memory 530 (e.g., a hard drive, an optical memory, a NAND or Flash memory, etc.). In some embodiments, either the volatile memory 520, the non-volatile memory 530, or a combination or portions thereof may be referred to as a “storage medium”. In various embodiments, the volatile memory 520 and/or the non-volatile memory 530 may be configured to store data in a semi-permanent or substantially permanent form.

In various embodiments, the information processing system 500 may include one or more network interfaces 540 configured to allow the information processing system 500 to be part of and communicate via a communications network. Examples of a Wi-Fi protocol may include, but are not limited to, Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to, IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

The information processing system 500 according to the disclosed subject matter may further include a user interface unit 550 (e.g., a display adapter, a haptic interface, a human interface device, etc.). In various embodiments, this user interface unit 550 may be configured to either receive input from a user and/or provide output to a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In various embodiments, the information processing system 500 may include one or more other devices or hardware components 560 (e.g., a display or monitor, a keyboard, a mouse, a camera, a fingerprint reader, a video processor, etc.). It is understood that the above are merely a few illustrative examples to which the disclosed subject matter is not limited.

The information processing system 500 according to the disclosed subject matter may further include one or more system buses 505. In such an embodiment, the system bus 505 may be configured to communicatively couple the processor 510, the volatile memory 520, the non-volatile memory 530, the network interface 540, the user interface unit 550, and one or more hardware components 560. Data processed by the processor 510 or data inputted from outside of the non-volatile memory 530 may be stored in either the non-volatile memory 530 or the volatile memory 520.

In various embodiments, the information processing system 500 may include or execute one or more software components 570. In some embodiments, the software components 570 may include an operating system (OS) and/or an application. In some embodiments, the OS may be configured to provide one or more services to an application and manage or act as an intermediary between the application and the various hardware components (e.g., the processor 510, a network interface 540, etc.) of the information processing system 500. In such an embodiment, the information processing system 500 may include one or more native applications, which may be installed locally (e.g., within the non-volatile memory 530, etc.) and configured to be executed directly by the processor 510 and directly interact with the OS. In such an embodiment, the native applications may include pre-compiled machine executable code. In some embodiments, the native applications may include a script interpreter (e.g., C shell (csh), AppleScript, AutoHotkey, etc.) or a virtual execution machine (VM) (e.g., the Java Virtual Machine, the Microsoft Common Language Runtime, etc.) that are configured to translate source or object code into executable code which is then executed by the processor 510.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive, etc.). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. A method comprising:
receiving a placed and routed circuit design, wherein the placed and routed circuit design includes a plurality of switch cells;
performing a supply voltage drop analysis on the placed and routed circuit design;
creating a voltage drop map detailing a plurality of supply voltage drops across the placed and routed circuit design as a function of physical position;
determining one or more low voltage drop portions of the placed and routed circuit design that are associated with respective voltage drops below a predetermined threshold value; and
altering one or more switch cells included by the respective one or more low voltage portions.

2. The method of claim 1, wherein determining one or more low voltage drop portions includes determining a plurality of tiers of voltage drop ranges, each tier associated with a respective threshold value; and
wherein altering one or more switch cells includes performing a different level of alteration for each low voltage drop portion associated with a respective tier.

3. The method of claim 1, wherein altering one or more switch cells includes resizing the switching cells.

4. The method of claim 1, wherein determining one or more low voltage drop portions includes determining portions based upon a functional unit block level of granularity.

5. The method of claim 1, wherein receiving a placed and routed circuit design occurs in any stage of integrated circuit design.

6. The method of claim 1, wherein performing a voltage drop analysis includes performing a dynamic IR drop analysis.

7. The method of claim 1, wherein altering one or more switch cells includes reducing a leakage power associated with the respective low voltage drop portions.

8. The method of claim 1, further comprising:
iteratively performing the method of claim 1, until a number of low voltage portions of the placed and routed circuit design are less than a threshold value.

9. An apparatus comprising:
a supply voltage drop analyzer configured to:
perform a supply voltage drop analysis on a placed and routed circuit design, wherein the placed and routed circuit design includes a plurality of switch cells, and
create a voltage drop map detailing a plurality of supply voltage drops across the placed and routed circuit design as a function of physical position; and
a processor configured to:
determine one or more low voltage drop portions of the placed and routed circuit design that are associated with respective voltage drops below a predetermined threshold value, and
alter one or more switch cells included by the respective one or more low voltage portions.

10. The apparatus of claim 9, wherein the processor is configured to:
determine a plurality of tiers of voltage drop ranges, each tier associated with a respective threshold value; and
perform a different level of alteration for each low voltage drop portion associated with a respective tier.

11. The apparatus of claim 9, wherein the processor is configured to convert one or more switch cells from a first type of switch cell to a second type of switch cell.

12. The apparatus of claim 9, wherein the processor is configured to determine portions based upon a functional unit block level of granularity.

13. The apparatus of claim 9, wherein the supply voltage drop analyzer is configured to perform a dynamic IR drop analysis.

14. The apparatus of claim 9, wherein the processor is configured to reduce a leakage power associated with the respective low voltage drop portions.

15. The apparatus of claim 9, wherein the processor is configured to:
generate an altered placed and routed circuit design based upon an alteration of one or more switch cells;
cause the supply voltage drop analyzer to perform a second supply voltage drop analysis on the altered placed and routed circuit design; and
alter, based upon the second supply voltage drop analysis, one or more switch cells included by the altered placed and routed circuit design.

16. A computer program product for designing an integrated circuit, the computer program product being tangibly and non-transitorily embodied on a computer-readable medium and including executable code for execution on an apparatus, the executable code comprising:
instructions to receive a placed and routed circuit design, wherein the placed and routed circuit design includes a plurality of switch cells;
instructions to perform a supply voltage drop analysis on the placed and routed circuit design;
instructions to create a voltage drop map detailing a plurality of supply voltage drops across the placed and routed circuit design as a function of physical position;
instructions to determine one or more low voltage drop portions of the placed and routed circuit design that are associated with respective voltage drops below a predetermined threshold value; and
instructions to alter one or more switch cells included by the respective one or more low voltage portions.

17. The computer program product of claim 16, wherein the executable code comprises:
instructions to determine a plurality of tiers of voltage drop ranges, each tier associated with a respective threshold value; and
instructions to perform a different level of alteration for each low voltage drop portion associated with a respective tier.

18. The computer program product of claim 16, wherein the executable code comprises:
instructions to perform at least one of: resize the switching cells, change a type of switch cell, or change type of transistor included by a switch cell.

19. The computer program product of claim 16, wherein the executable code comprises:
instructions to perform a dynamic IR drop analysis.

20. The computer program product of claim 16, wherein the executable code comprises:
instructions to reduce a leakage power associated with the respective low voltage drop portions.
